(19) United States
(12) Patent Application Publication
(10) Pub. No.: US 2026/0225258 A1
(43) Pub. Date: Aug. 6, 2026

(54) SKIN EMBEDDED MARKERS FOR DYNAMIC PROJECTION MAPPING OF ANIMATRONIC FIGURES

(71) Applicant: DISNEY ENTERPRISES, INC., Burbank, CA (US)

(72) Inventors: Joel Jason Peavy, Poway, CA (US); David Powell Goldberg, Altadena, CA (US); Alfredo Medina Ayala, West Covina, CA (US); David Robert Wyatt Rose, Glendale, CA (US); Prutsdom Jiarathanakul, Glendale, CA (US); Robert B. Engle, Los Angeles, CA (US)

(21) Appl. No.: 19/531,980

(22) Filed: Feb. 6, 2026

Related U.S. Application Data
(60) Provisional application No. 63/755,000, filed on Feb. 6, 2025.

(51) Int. Cl. B25J 11/00; H04N 9/31

(52) U.S. Cl. CPC B25J 11/0015; H04N 9/3182; H04N 9/3185

(57) ABSTRACT

A system includes an animatronic skin having one or more embedded markers configured to provide a light signature, a camera configured to detect the light signature, a projector configured to project content onto the animatronic skin, and a controller configured to determine positions of the markers based on the light signature and modify the projected content based on the positions of the markers. A light source may generate an invisible light, and the light signature may be produced or resulting from the invisible light interacting with the markers. The light signature may be the result of UV or IR pigment of the markers. The markers may be defined by LEDs or fiber optics. To manufacture the skin, the markers may be defined within a mold, and a material may be poured within the mold, wherein the material defines the skin when cured with the markers embedded therein.

### CROSS REFERENCE TO RELATED APPLICATIONS

The present application claims the benefit of and priority to U.S. Provisional Patent Application No. 63/755,000, filed Feb. 6, 2025, which is incorporated by reference herein in its entirety.

### FIELD

The present disclosure relates generally to systems and methods for controlling and implementing robotic devices, such as animatronic figures, and more specifically to dynamic projection mapping of animatronic figures.

### BACKGROUND

Dynamic projection mapping of animatronic figures relies on accurately aligning projected visuals with physical objects in a real-time render system. This requires a virtual camera in the rendering engine to match the real-world location and orientation of the object being projected onto. Traditionally, this is achieved using quick response (QR) code fiducials attached to the object, structured lighting to assist in spatial recognition, and the use of Multiple Projection Common Data Interchange (MPCDI) to set the virtual camera to match the real-world projector.

This method, however, presents several limitations. For example, this method requires the use of manual human intervention that is time-consuming and prone to error, such as manual placement and removal of fiducials each time the system is used. The frequent manual intervention slows down deployment and increases labor costs. The fiducials can also interfere with the aesthetic or immersive quality of the object being project onto. This traditional method also does not support automatic calibration or setup, limiting scalability and responsiveness. In addition, this method requires syncing real-world mechanical rotational data with virtual nodal point that mimic the real-world mechanical joints.

### SUMMARY

In one example, a system includes an animatronic skin including a plurality of markers configured to provide a light signature, wherein the plurality of markers is embedded at least partially within the animatronic skin; a camera configured to detect the light signature; a projector configured to project content onto the animatronic skin; and a controller configured to determine positions of the plurality of markers based on the light signature, and modify the projected content based on the positions of the plurality of markers.

Optionally, the system includes an actuator configured to create a movement of the animatronic skin, wherein the controller is configured to modify the projected content based on the movement of the animatronic skin.

Optionally, the plurality of markers is embedded within the animatronic skin to move with the animatronic skin.

Optionally, the plurality of markers includes light-emitting diodes (LEDs) or fiber optics embedded at least partially within the animatronic skin.

Optionally, the system includes a light source configured to project an invisible light onto the animatronic skin, wherein the light signature is a light resulting from the invisible light interacting with the markers. The invisible light may include ultraviolet (UV) light or infrared (IR) light.

In another example, a system includes a light source configured to generate an invisible light, a camera configured to detect a characteristic of the invisible light, and a controller configured to determine positions of markers associated with a skin of an animatronic based on the characteristic of the invisible light and modify a projected content of a projector based on the positions of the markers.

Optionally, the system includes the projector, wherein the projector is configured to generate the projected content for projection onto the skin.

Optionally, the system includes the skin, wherein the skin includes the markers, and the markers are embedded at least partially within the skin.

Optionally, the markers are defined at least partially by paint comprising ultraviolet (UV) or infrared (IR) pigment.

Optionally, the markers are defined by LEDs or fiber optics, and wherein the LEDs or fiber optics generate or transmit the invisible light.

Optionally, the system includes the animatronic and an actuator configured to change a topography of the skin, wherein the controller is configured to modify the projected content based on the change of the topography.

Optionally, the light source is configured to emit UV light or IR light onto the skin, and wherein the camera is configured to detect a light resulting from the UV light or the IR light interacting with the markers.

In another example, a method for projecting content onto a skin of an animatronic includes generating, by a light source, an invisible light; detecting, by a camera, a light resulting from the invisible light interacting with markers embedded at least partially within the skin of the animatronic; determining, based on the light detected by the camera, positions of the markers; and modifying a projected content of a projector based on the positions of the markers.

Optionally, the detecting the light includes detecting the light reflected off the markers.

Optionally, the detecting the light includes detecting a light generated by the markers.

Optionally, the method includes projecting the projected content onto the skin of the animatronic.

Optionally, the method includes modifying a topography of the skin of the animatronic, wherein the modifying the projected content includes adjusting the projected content based on the modified topography.

In another example, a method of manufacturing a skin of an animatronic includes defining one or more markers within a mold, wherein the one or more markers are configured to provide a light signature; and pouring a material within the mold, wherein the material defines the skin of the animatronic when cured with the one or more markers embedded therein.

Optionally, the defining the one or markers includes placing a stencil onto the mold and spraying a paint through the stencil and onto the mold, wherein the paint includes UV or IR pigment configured to provide the light signature.

### BRIEF DESCRIPTION OF THE DRAWINGS

FIG. 1 illustrates a simplified schematic of a system for performing dynamic projection mapping onto animatronic figures in real-time.

FIG. 2 illustrates a view of an example skin of an animatronic figure when viewed under a first light.

FIG. 3 illustrates a view of an example skin of an animatronic figure when viewed under a second light.

FIG. 4A illustrates a first stage of an example process of embedding markers in a skin of an animatronic figure.

FIG. 4B illustrates a second stage of an example process of embedding markers in a skin of an animatronic figure.

FIG. 4C illustrates a third stage of an example process of embedding markers in a skin of an animatronic figure.

FIG. 5 illustrates a first system configured to detect markers embedded in a skin of an animatronic figure.

FIG. 6 illustrates a second system configured to detect markers embedded in a skin of an animatronic figure.

FIG. 7 illustrates a third system configured to detect markers embedded in a skin of an animatronic figure.

FIG. 8 illustrates an example process of dynamic projection onto a skin of an animatronic.

FIG. 9 illustrates an example process for projecting content onto a skin of an animatronic.

FIG. 10 illustrates a simplified block diagram of components of a computing system.

### DETAILED DESCRIPTION

Embodiments herein introduce a procedure for animating a robotic device (e.g., an animatronic figure), such as animation of a portion of a face, limb, or other element of the animatronic figure. The animation may include a hybrid approach using mechanical actuators combined with content projection, where the content is projected onto a projection surface of the animatronic (e.g., an outer covering or skin of the animatronic). The content projection may enhance or supplement the mechanical motion. For example, animation, detailed realism, special effects, and artistic elements of facial features, including, but not limited to, skin texture, color, macro and micro animations, wrinkles, cinematic effects, visual effects (VFXs), etc. are projected along with mechanical motion representative of the same animated effect. The overall effect of the mechanical and projected content creates a realistic and immersive experience not possible to generate solely with mechanical motion. The combination of topography changes (e.g., via mechanical motion) with the content projection over the same surface of the animatronic introduces realism and allows more complex and detailed animations for the animatronic, many of which would not be possible to create with just mechanical motion or with just content projection, such as finer or faster motions that cannot be done with mechanical actuators.

In some embodiments, a position, orientation, or pose of the animatronic figure (e.g., the skin of the animatronic) is tracked or otherwise identified using one or multiple markers associated with the skin. In many instances, the orientation may be tracked in real-time to ensure alignment and accurate projection between the projected content and the projection surface or skin. For example, the tracked pose of the animatronic figure is used by a real-time rendering engine to render a desired image or video frame (e.g., desired artistic content) to be projected onto the animatronic figure by one or more projectors based on the position (e.g., topography, deformation, pose) of features of the projection surface. The tracking may be accomplished using invisible ultraviolet (UV) or infrared (IR) markers embedded in the skin, such as combined with automated computer vision tracking and advanced feature recognition algorithms.

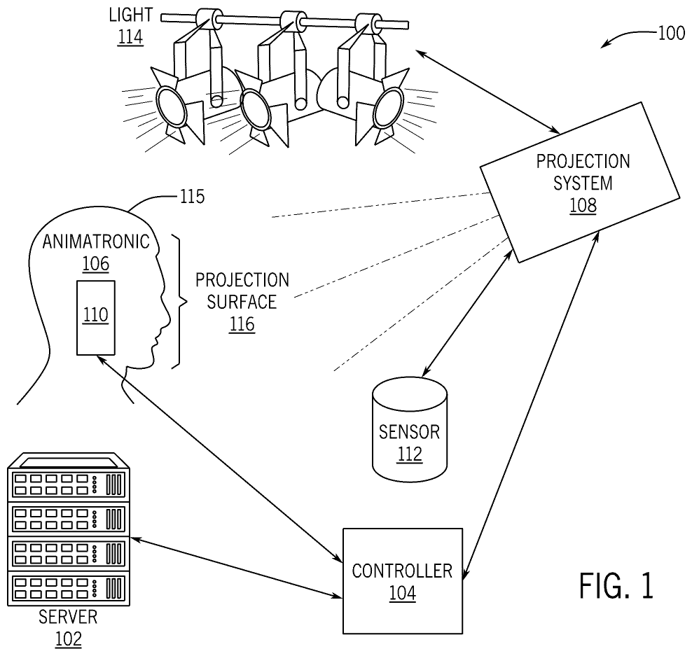

FIG. 1 illustrates a simplified schematic of a system 100 for performing dynamic projection mapping onto robotic devices (e.g., animatronic figures) in real-time. In one example, the system 100 includes a server 102, a controller 104, an animatronic figure (hereinafter “animatronic”) 106, one or more actuators 110, a projection system 108, one or more sensors 112, and one or more lights 114. In another example, the system 100 includes a combination of the server 102, the controller 104, the animatronic 106, the one or more actuators 110, the projection system 108, the one or more sensors 112, or the one or more lights 114.

The animatronic 106 may include a skin 115 (e.g., an “animatronic skin”). The animatronic 106 may receive mechanical inputs from the controller 104 and performed by one or more actuators 110 as to change the topography or otherwise deform the projection surface 116. The actuator 110 may change the topography or deform the projection surface 116 in a manner described in U.S. Nonprovisional Ser. No. 19/407,596, filed Dec. 3, 2025, which is incorporated by reference herein. In one example, the actuator 110 is positioned beneath or behind the projection surface 116 or skin 115 to move the surface or skin from behind and acts to deform or create ridges, recesses, or the like to the surface. In some examples, the skin 115 is the projection surface 116. Additionally, the projection system 108 may project content onto the projection surface 116 of the animatronic 106.

The projection system 108 may receive data from the controller 104. The data corresponds to content that is to be projected onto the animatronic 106. The projection system 108 may project the content onto the animatronic 106. The projection system 108 may include a projector or multiple projectors having a lens system configured to control the image quality and/or magnification. The projection system 108 may optionally include one or more mirrors and/or one or more filters. In some examples, the projection system 108 may adjust what content is being projected onto the animatronic 106 or how the content is being projected onto the animatronic 106 to better align the projection of the content with the projection surface 116 of the animatronic 106. The sensors 112 may collect data pertaining to the animatronic 106 (e.g., the skin 115, the actuator 110, etc.), the lights 114 illuminating the animatronic 106, environmental conditions, or a combination thereof. In some examples, the sensors 112 may include a camera. The sensors 112 may track the animatronic 106 (e.g., the skin 115) using any of the tracking procedures discussed herein. In another example, the sensors 112 may track the animatronic 106 or skin 115 in a manner described in U.S. Nonprovisional Ser. No. 19/448,401, filed Jan. 14, 2026, which is incorporated by reference herein. The projection system 108 may include different projectors (e.g., light, lasers, video, environmental projectors, etc.), such as used in combination, to achieve the projection of content onto the animatronic 106.

In some cases, the controller 104 may receive data from the animatronic 106 (e.g., topography, position, orientation, movement data) or the projection system 108 (e.g., content-based data, data generated from digital media, data on how the content is being projected (e.g., projection performance data), and/or data from the lights 114). Additionally, or alternatively, the controller 104 may receive data collected by the sensors 112 corresponding to the animatronic 106 (e.g., data corresponding to tracking the skin 115). The controller 104 may use such data (e.g., feedback) to align the projection surface 116 of the animatronic 106 and the content being projected by the projection system 108. Additionally, the controller 104 may transmit such data received from the animatronic 106 and the projection system 108 to the server 102 for storage, for use in future animation or, in some cases, model training. The controller 104 may receive from the server 102, previous data obtained from the animatronic 106 and the projection system 108 to better align the projection surface 116 of the animatronic 106 and the content being projected by the projection system 108. The controller 104 may transmit mechanical movements to the animatronic 106 to be performed by the actuator 110 that may be used to adjust the topography of the projection surface 116 of the animatronic 106. The controller 104 may transmit content to the projection system 108 to be projected by the projection system 108 onto the projection surface 116 of the animatronic 106.

The server 102 may transmit stored data to the controller 104 and/or receive data from the controller 104 for storage corresponding to the animatronic 106 (e.g., topography, position, orientation, movement data, skin data, etc.) and to the projection system 108 (e.g., content based data, data on how the content is being projected from, for example, the sensors 112 and/or lights 114). In some examples, this data may be used for future animation and/or model training.

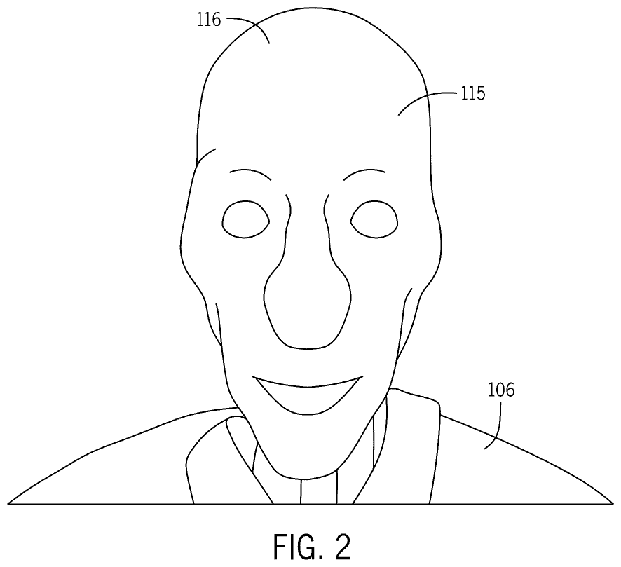

FIG. 2 illustrates a view of the skin 115 when viewed under a first light. The skin 115 may define the one or more projection surfaces 116 onto which content may be projected. In this manner, the projection surface 116 may be a surface covering at least a portion of the animatronic 106, e.g., a head of the animatronic 106 or any other part of the animatronic 106 desired to be animated. The projection surface 116 may cover a single moving surface or multiple moving surfaces of the animatronic 106. In such examples, the skin 115 may move (e.g., via an actuator or a moving surface) to provide a dynamic visual effect. Example dynamic effects may include movement of the nose, eyes, mouth, forehead, cheeks, or chin areas of the animatronic 106 or skin 115. In other examples, the skin 115 may be fixed in place. For example, the skin 115 may define a static projection surface such that any dynamic visual effect is provided by the projection of the content itself onto the skin 115. The skin 115 may stretch or deform, such as to accommodate movement and/or the underlying structure of the animatronic 106. In some examples, the skin 115 may may be shaped, contoured, or otherwise formed to create visual features of the skin 115 or animatronic 106. Example visual features may include lip, nose, eye, or other facial features, such as to mimic the features of a fictional or nonfictional character. In some examples, the skin 115 may be unremarkable when viewed under the first light, such as void of features not typical of real skin. The first light may be a first spectrum of light, such as a spectrum visible to the human eye (e.g., sunlight, natural light, generated light visible to the human eye, etc.). In this manner, the first light may be visible light.

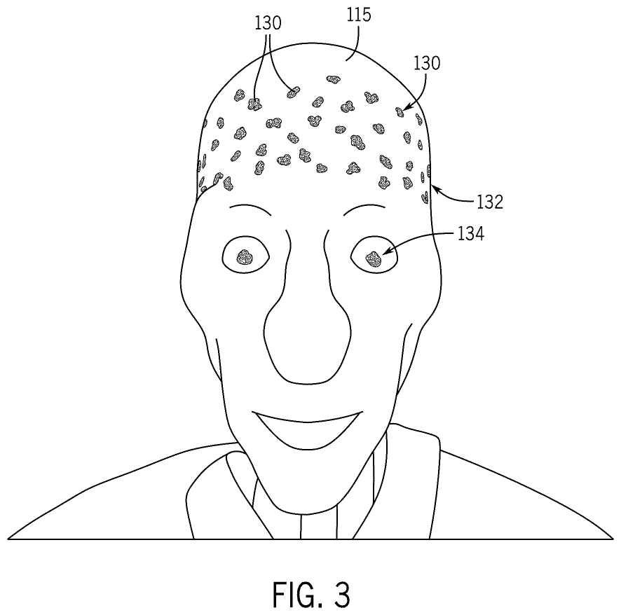

FIG. 3 illustrates a view of the skin 115 when viewed under a second light. In some examples, the skin 115 may include one or multiple markers 130. The markers 130 may be intrinsic to the skin 115. In one example, the markers 130 may be located on or near the surface of the skin 115. In another example, the markers 130 may be embedded, at least partially, in the skin 115. In other examples, the markers 130 may form or define at least a portion of the skin 115 itself (e.g., the surface, etc.). The markers 130 may be positioned randomly or in a set pattern, at a desired density or count, etc. Each marker 130 may include one or more unique features, such as curves, points, edges, codes, etc. In the example illustrated in FIG. 3, the skin 115 includes a first set of markers 132 and a second set of markers 134. The first set of markers 132 may be in the forehead area, although other areas or locations are contemplated. The second set of markers 134 may be associated with a different facial feature. For example, the second set of markers 134 may include two markers 130 added to the eyes.

The markers 130 may be placed in a symmetric or a nonsymmetric pattern along the skin 115. In addition, each marker 130 may include a different surface pattern, or multiple markers 130 may include a similar surface pattern. The location pattern of the group of markers 130 and/or the surface pattern of the markers 130 themselves may facilitate locating the skin 115 for dynamic projection. For example, the markers 130 may be used to determine the position and orientation of the skin 115 for accurate projection of content onto the skin 115, to match the projected content with movement of the skin 115, to match the real-world location and orientation of the skin 115 being projected onto, etc. In this manner, the markers 130 may act as fiducials to locate the skin 115 relative to the projection system 108. Although described with reference to the skin 115, the markers 130 may be associated with different portions of the animatronic 106. In such examples, the markers 130 may be tracked for motion capture of the animatronic, such as in combination with inertial measurement units for increased accuracy.

The markers 130 may be configured to provide a light signature, such as when viewed under the second light. The second light may be a spectrum of light different than the first light. For example, the second light may be a spectrum invisible to the human eye (e.g., invisible light, electromagnetic radiation outside the visible spectrum or radiation beyond the human range). In one example, the second light may include an ultraviolet (UV) light. In another example, the second light may include an infrared (IR) light. When viewed under the second light, the markers 130 may become visible. In other examples, the markers 130 may be detected by a sensor configured to detect an invisible light spectrum, as described below. For example, the markers 130 may be painted with or include a pigment detectable only in the invisible spectrum. In one example, the light signature provided by the markers 130 may include a reflection of the invisible light off the markers 130, with the reflection detectable by the sensor (e.g., a camera). In another example, interaction of the invisible light with the markers 130 may produce a light (e.g., fluorescent light, luminescent light) that is detected by the sensor (e.g., a camera).

With additional reference to FIG. 2, the markers 130 may not be visible to the human eye (e.g., not visible to a viewer). When embedded within the skin 15, the markers 130 may move with skin 115, such as undetected by the viewer.

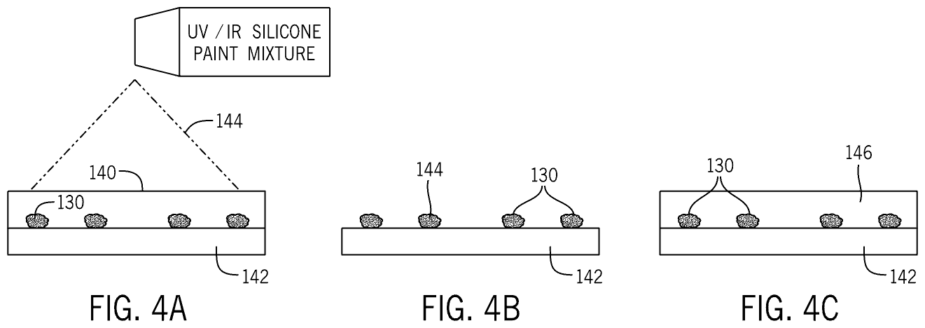

FIGS. 4A-4C illustrate an example process of embedding the markers 130 in the skin 115 (e.g., manufacturing the skin 115). Referring to FIG. 4A, one or more markers 130 may be defined within a mold 142. For example, a stencil 140 may be created or obtained. The stencil 140 may have a pattern for the markers 130. The stencil 140 may be three-dimensional (3D) printed with the pattern. In this manner, the pattern may be accurate, repeatable, and match specifications (e.g., to match a CAD model). The stencil 140 may be placed inside the mold 142. For example, the stencil 140 may be placed onto the inner side of the mold 142. With the stencil 140 in place, a paint 144 may be sprayed through the stencil 140 and onto the inner side of the mold 142. The paint 144 may be a clear silicone paint with UV or IR pigment mixed in. The paint 144 may define the markers 130 themselves, or the paint 144 may be sprayed onto markers 130 placed inside the mold 142.

Referring to FIG. 4B, the stencil 140 may be removed and the paint 144 allowed to dry. Referring to FIG. 4C, a material 146 may be poured into the mold 142 and the material 146 allowed to cure (e.g., dry or harden). Once cured, the material 146 defines the skin 115, with the markers 130 embedded therein. The material 146 may be or include silicone or a different material, such as self-healing elastomers, graphene-infused silicone, or liquid crystal elastomers. The material 146 may be chosen to accommodate movement of the skin 115 or animatronic 106 (e.g., to increase lifespan, to reduce tearing, or to improve elasticity for more expressive motion). In such examples, the embedded markers 130 may move with the skin 115. The material 146 may bond with the paint 144 that has dried in the mold 142. As a result, the paint 144 may be smooth and integral to the skin 115. In addition, the skin 115 may have an outer surface to specification (e.g., to match a CAD model). In some examples, the markers 130 may be defined by different elements or components. For example, the markers 130 may be defined by light-emitting diodes (LEDs), fiber optics, or another element. In such examples, the LEDs or fiber optics may be embedded in the skin 115 in a manner similar to that described above.

In some examples, the skin 115 may include additional elements. For example, the skin 115 may include embedded soft robotics, shape-memory alloys, or electroactive polymers configured to enable micro expressions and subtle movements of the skin 115, such as combined with dynamic skin tracking and projection. In another example, the skin 115 may include one or more micro displays, providing visual illusions or other effects.

In some examples, the skin 115 may be modular. For example, the skin 115 may be divided into interchangeable sections (e.g., forehead, cheeks, jaw, etc.). In such examples, damaged sections can be replaced individually, reducing downtime and cost.

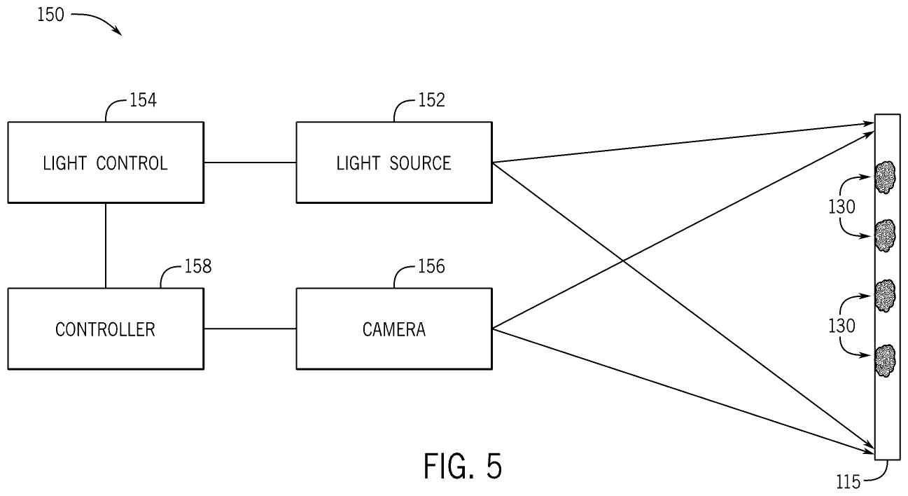

FIG. 5 illustrates a first system 150 configured to detect the markers 130 of the skin 115. The first system 150 may be implemented in a pigment-based application. For example, the first system 150 may be configured to detect markers 130 defined by UV or IR points or objects embedded in the skin 115 (e.g., through the process illustrated in FIGS. 4A-4C). The first system 150 may include a light source 152, a light control 154, a camera 156, and a controller 158, or a combination thereof. The light source 152 may generate invisible light (e.g., projected onto the skin 115). For example, the light source 152 may be a UV light source or an IR light source. The light control 154 may manage the light generated by the light source 152. For example, the light control 154 may control brightness, color, or timing, among other characteristics, of the light generated by the light source 152, such as based on instructions or commands received from the controller 158. The light control 154 may automate the light source 152, such as based on the content to be projected onto the skin 115.

The camera 156 may be configured to detect the markers 130 (e.g., based on a light signature of or produced by the markers 130). For example, the camera 156 may be configured to detect, in part, UV or IR light reflected off the markers 130. In another example, the camera 156 may be configured to detect, in part, a light resulting or produced from the UV or IR light interacting with the markers 130. For example, the markers 130 may include UV ink or IR ink. In such examples, the camera 156 may detect a fluorescent light resulting or produced when UV light interacts with UV ink or a fluorescent or luminescent light resulting or produced when IR light interacts with IR ink. In one implementation, the camera 156 is a near IR-visible range camera, although other configurations are contemplated, including a visible light camera, a UV sensitive camera, an IR sensitive camera, etc. In one example, the camera 156 may be integrated with the light source 152 (e.g., a single apparatus or device defining or including both the light source 152 and the camera 156). In another example, the camera 156 is separate from the light source 152, such as the light source 152 and the camera 156 defined by separate apparatuses or devices. The camera 156 may be positioned to view the skin 115 or the light reflected off the skin 115 or generated by the markers 130, either directly or indirectly through reflective surfaces, lenses, or modifiers. The camera 156 may be positioned relative to the light source 152 for a desired imaging of the skin 115 or light. For example, the camera 156 may be positioned above, below, or to the side of the light source 152.

The controller 158 may be any type of electronic device capable of processing, receiving, and/or transmitting instructions. For example, the controller 158 may be a central processing unit, microprocessor, processor, or microcontroller. The controller 158 may include one or multiple processing elements to control the light source 152 (e.g., the light control 154) and the camera 156. The controller 158 may be communicatively coupled to the light control 154 and the camera 156. For example, the controller 158 may communicate with the light control 154 and the camera 156 via a wired or wireless connection (e.g., Wi-Fi, Bluetooth, etc.).

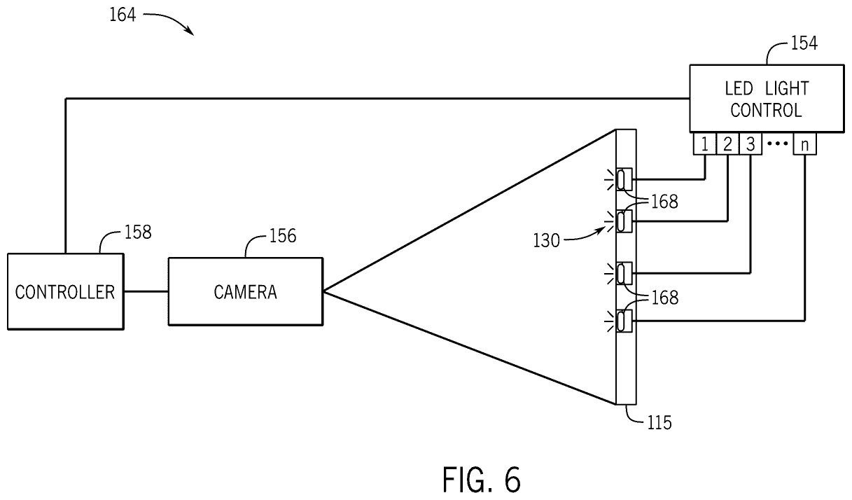

FIG. 6 illustrates a second system 164 configured to detect the markers 130 of the skin 115. The second system 164 may be implemented in an LED-based application. For example, the second system 164 may be configured to detect the markers 130 defined by LEDs 168 embedded in the skin 115. In such examples, the LEDs 168 may define the light source 152, described above. For example, the LEDs 168 may generate invisible light (e.g., UV, IR, etc.) from within or on the skin 115. In one example, the optical lenses of the LEDs 168 may be provided with a special treatment (e.g., a treatment that performs optical shaping and/or surface modification) for a required field-of-view (FOV) of the camera 156. Examples of special treatments include, but are not limited to, a beam-shaping lens or other lens profile configured to change an LED emission angle, match the camera 156's horizontal or vertical FOV, and/or reduce light outside a usable image area of the camera 156; a diffuser (e.g., frosted or textured lens surfaces, embedded diffusive particles in the lens material, etc.) configured to scatter light to create a more uniform illumination within the FOV of the camera 156; micro-scale features molded or etched into the lens surface; anti-reflective coatings on the lens surface; angular cutoff or masking that limits emission outside a certain angle; and/or wavelength-specific coatings.

With continued reference to FIG. 6, the second system 164 may include the light control 154, the camera 156, and the controller 158, described above. The light control 154 may be an LED light control configured to control the LEDs 168. For example, the light control 154 may include separate outputs for connection to a respective LED within the skin 115. In another example, the light control 154 may include a pulsed frequency modulation of the light source (e.g., thereby giving each LED 168 a unique identity). The light control 154 may be defined by one unit or multiple units connected together, based on the number of LEDs 168 and the number of outputs of each unit.

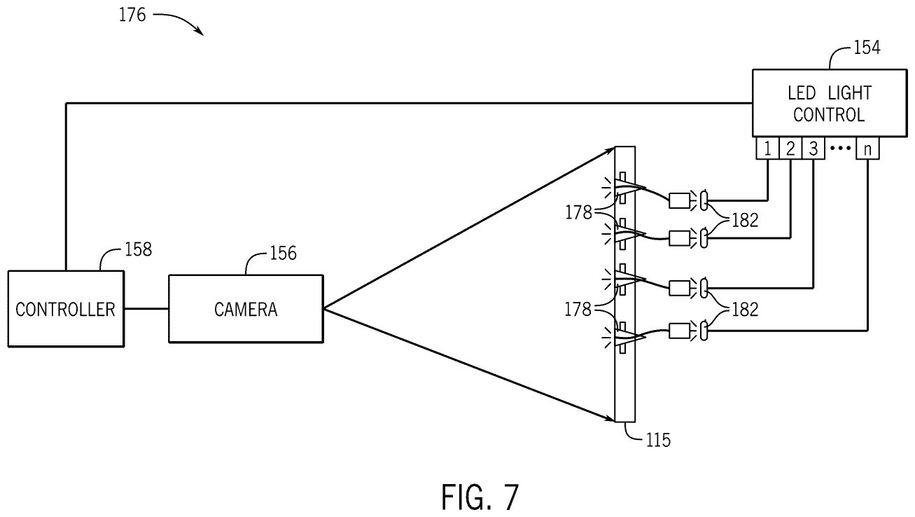

FIG. 7 illustrates a third system 176 configured to detect the markers 130 of the skin 115. The third system 176 may be implemented in a fiber optic-based application. For example, the third system 176 may be configured to detect the markers 130 defined by fiber optics 178 embedded in the skin 115. In such examples, the fiber optics 178 may provide or define, at least partially, the light source 152, described above. For example, the fiber optics 178 may transmit invisible light (e.g., UV, IR, etc.) generated by one or more fiber optic LED couplers 182 (e.g., LEDs or laser diodes). In one example, the tip of the fiber optics 178 may be provided with a special treatment for a required field-of-view (FOV) of the camera 156. Any of the special treatments described above with respect to LEDs 168 may be used. The fiber optics 178 may have a durometer that is greater than the skin durometer.

With continued reference to FIG. 7, the third system 176 may include the light control 154, the camera 156, and the controller 158, described above. The light control 154 may be an LED light control configured to control the one or more fiber optic LED couplers 182. For example, the third system 176 may include one fiber optic LED coupler 182 per fiber optic 178 within the skin 115. The light control 154 may include a pulsed frequency modulation of the light source (e.g., thereby giving each fiber optic 178 or fiber optic LED coupler 182 a unique identity). The light control 154 may include separate outputs for connection to a respective fiber optic LED coupler 182. The light control 154 may be defined by one unit or multiple units connected together, based on the number of fiber optics 178 and the number of outputs of each unit.

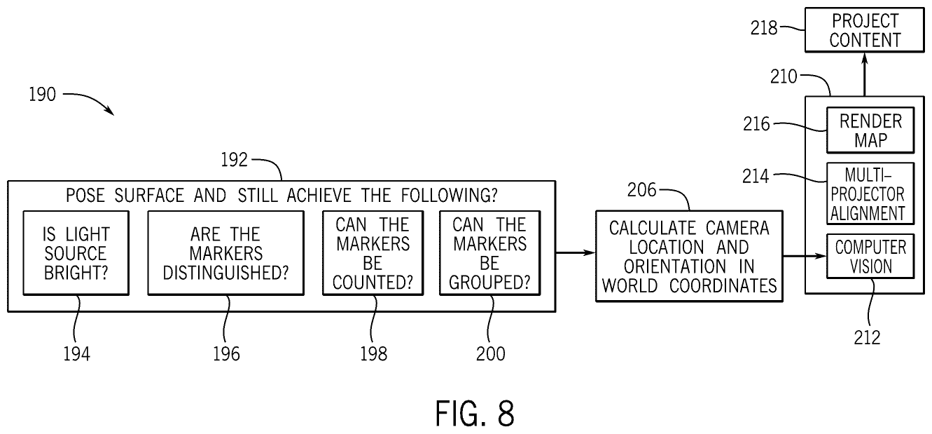

FIG. 8 illustrates an example process 190 of dynamic projection onto the skin 115 using the projection system 108. Block 192 includes detecting the markers 130. For example, the camera 156 may detect the markers 130, LEDs 168, or fiber optics 178 based on invisible (e.g., UV, IR) light. Block 192 may include one or multiple steps. At step 194, the process 190 may determine whether the markers 130 are visible. For example, step 194 may determine whether the markers 130 are bright enough for detection. The light source 152 may be adjusted based on the determination in step 194. For example, the light control 154 may increase the brightness of the light source 152 if the markers 130 are not bright (e.g., based on a comparison to a threshold level). In another example, the light control 154 may adjust a different characteristic of the light for improved detection.

At step 196, the process 190 may determine whether the markers 130 are distinguishable. For example, step 196 may determine whether the individual markers 130 or the array patterns of the markers 130 can be clearly distinguished from one another or from the skin 115 (e.g., based on a comparison to a threshold level). Based on the determination in step 196, the process 190 may adjust the projected content.

At step 198, the process 190 may determine whether the markers 130 can be counted. For example, step 198 may count the markers 130 to determine whether all markers 130 are detected. Based on the number of counted markers 130, the process 190 may adjust the projected content.

At step 200, the process 190 may determine whether the markers 130 can be grouped. For example, step 200 may group the markers 130 based on location or a correspondence with known anatomy (e.g., within the forehead region, at the eyes of the animatronic 106, etc.). In another example, the markers 130 may be grouped based on distance, visibility, or a different characteristic. Based on the grouping of the markers 130, the process 190 may adjust the projected content.

At step 206, the process 190 calculates camera location and orientation in real-world coordinates. Based on the detected positions of the markers 130 within the skin 115, the process 190 may determine the position of the camera 156 relative to the skin 115. In one example, the process 190 may calculate the relative position of the camera 156 dynamically as the animatronic moves, as the skin 115 changes topography, as the camera 156 moves, etc. In this manner, the relative positioning of the camera 156 and the skin 115 may be known or approximated to a high degree. With the position of the camera 156 relative to the skin 115 known, the content projected by the projection system 108 may be aligned with the skin 115, such as dynamically in real-time or near real-time, to provide a more accurate and complete projection onto the skin 115. As a result, an immersive experience of a guest viewing the animatronic may be improved. The initial alignment or adjustment of the projected content with the skin 115 may also be automated, such as to provide an automatic calibration or setup, to automatically adjust as conditions changes, etc.

Block 210 includes calibrating the projection system 108. Block 210 may include one or multiple steps. At step 212, the process 190 may include processing one or more camera images using a machine learning algorithm. For example, step 212 may include structured light analysis or other computer-vision techniques including machine learning. Step 212 may include image classification and segmentation using a neural network. Step 212 may include a computer vision algorithm to detect and describe local features in the captured images. In one example, step 212 may utilize a scale-invariant feature transform (SIFT) to detect and describe features in the images, even when the images are scaled, rotated, or transformed in other ways.

At step 214, the process 190 may align multiple projectors of the projection system 108. Multi-projector display systems may utilize calibration techniques to align projected content across multiple projection devices to present a visually unified image. Such calibration may include geometric correction, warping, edge blending, and color alignment to compensate for relative projector positions, orientations, and projection surfaces. One example of an industry approach to multi-projector calibration involves standardized data formats that allow calibration information to be exchanged among different projection and rendering components. These formats may store information describing projector geometry, blending regions, and other alignment parameters to facilitate coordinated display across multiple projectors. An example of such a standardized format is the Multiple Projection Common Data Interchange (MPCDI), which is used to represent calibration and alignment information for multi-projector systems. In this manner, multiple projectors of the projection system 108 may be combined to create a continuous image projected onto the skin 115.

At step 216, the process 190 may include rendering a render map of the skin 115. The render map may correspond to a tracking of the skin 115 through the markers 130. The render map may be dynamic, such as changing or adjusting as the animatronic 106 or skin 115 moves.

At step 218, the process 190 may project content onto the skin 115. The content may be projected using one or multiple projectors of the projection system 108. The content may be projected based on the calculated location of the camera 156 relative to the skin 115. The content may be projected based on the render map of the skin 115 (e.g., to correspond to the render map of the skin 115). For example, the projected content may be dynamically synced to the render map, such as in a manner described in U.S. Nonprovisional Ser. No. 19/448,401, filed Jan. 14, 2026, which is incorporated by reference herein.

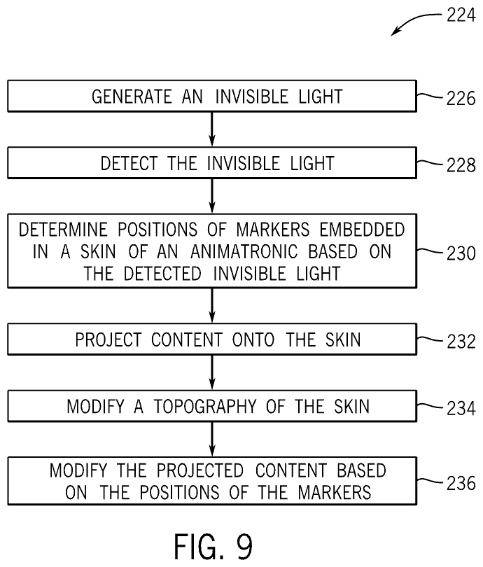

FIG. 9 illustrates an example process 224 for projecting content onto the skin 115. At step 226, the process 224 includes generating light in the non-visible spectrum (hereinafter “invisible light”). For example, the light source 152 may generate UV light (approximately below 380 nm) or IR light (approximately above 750 nm) that is not visible to the human eye. At step 228, the process 224 includes detecting the invisible light. For example, the camera 156 may detect the invisible light, such as in a manner as described above.

At step 230, the process 224 includes determining positions of the markers 130 embedded in the skin 115. The positions may be determined based on the invisible light detected by the camera 156. For example, the camera may detect the positions of the markers 130 based on a light resulting from light interacting with the markers 130. Determining the positions of the markers 130 may improve or enhance content projected onto the skin 115. For example, projected content may be dynamically adjusted to sync the projected content with the position and orientation of the skin 115, based on the positions of the markers 130.

At step 232, the process 224 includes projecting content onto the skin 115, such as in a manner as described above.

At step 234, the process 224 includes modifying a topography of the skin 115. For example, the actuators 110 may be controlled to change the skin's topography, thereby deforming or changing the projection surface 116.

At step 236, the process 224 includes modifying the projected content based on the positions of the markers 130. For example, step 236 may include modifying or adjusting the projected content to match the position, orientation, or pose of the animatronic FIG. 106 or skin 115 (e.g., determined based on the detected markers 130) to ensure alignment and accurate projection between the projected content and the skin 115. Step 236 may include adjusting the projected content based on the modified topography of the skin 115 (e.g., to ensure alignment and accurate projection between the projected content and the skin 115). In other words, rather than driving movement of the animatronic 106 based on content, step 236 may include driving the projected content based on mechanical movement of the animatronic 106 or skin 115.

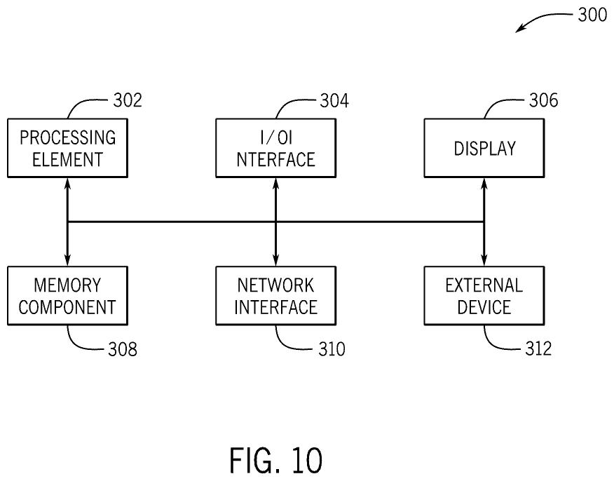

FIG. 10 is a simplified block diagram of components of a computing system 300 of the system 100, such as the server 102, the animatronic 106, the projection system 108, the controller 104, the controller 158, etc. For example, the processing element 302 and the memory component 308 may be located at one or in several computing systems 300. This disclosure contemplates any suitable number of such computing systems 300. For example, the server 102 may be a desktop computing system, a mainframe, a blade, a mesh of computing systems, a laptop or notebook computing system, a tablet computing system, an embedded computing system, a system-on-chip, a single-board computing system, or a combination of two or more of these. Where appropriate, a computing system 300 may include one or more computing systems 300; be unitary or distributed; span multiple locations; span multiple machines; span multiple data centers; or reside in a cloud, which may include one or more cloud components in one or more networks. A computing system 300 may include one or more processing elements 302, an input/output I/O interface 304, one or more external devices 312, one or more memory components 308, and a network interface 310. Each of the various components may be in communication with one another through one or more buses or communication networks, such as wired or wireless networks, e.g., the controller 158. The components in FIG. 10 are exemplary only. In various examples, the computing system 300 may include additional components and/or functionality not shown in FIG. 10.

The processing element 302 may be any type of electronic device capable of processing, receiving, and/or transmitting instructions. For example, the processing element 302 may be a central processing unit, microprocessor, processor, or microcontroller. Additionally, it should be noted that some components of the computing system 300 may be controlled by a first processing element 302 and other components may be controlled by a second processing element 302, where the first and second processing elements may or may not be in communication with each other. The processing element 302 may implement the methods described herein, such as process 190 or process 224.

The I/O interface 304 allows a user to enter data in to computing system 300, as well as provides an input/output for the computing system 300 to communicate with other devices or services. The I/O interface 304 can include one or more input buttons, touch pads, touch screens, and so on.

The external device 312 are one or more devices that can be used to provide various inputs to the computing systems 300, e.g., mouse, microphone, keyboard, trackpad, sensing element (e.g., a thermistor, humidity sensor, light detector, etc. The external devices 312 may be local or remote and may vary as desired. In some examples, the external devices 312 may also include one or more additional sensors.

The memory components 308 are used by the computing system 300 to store instructions for the processing element 302, as well as store data. The memory components 308 may be, for example, magneto-optical storage, read-only memory, random access memory, erasable programmable memory, flash memory, or a combination of one or more types of memory components.

The network interface 310 provides communication to and from the computing system 300 to other devices. The network interface 310 includes one or more communication protocols, such as, but not limited to Wi-Fi, Ethernet, Bluetooth, etc. The network interface 310 may also include one or more hardwired components, such as a Universal Serial Bus (USB) cable, or the like. The configuration of the network interface 310 depends on the types of communication desired and may be modified to communicate via Wi-Fi, Bluetooth, etc.

The display 306 provides a visual output for the computing system 300 and may be varied as needed based on the device. The display 306 may be configured to provide visual feedback and may include a liquid crystal display screen, light emitting diode screen, plasma screen, or the like. In some examples, the display 306 may be configured to act as an input element through touch feedback or the like.

The computing system 300 may be include a physical device or separate physical devices including components to read and execute instructions from a machine-readable or computer-readable medium (e.g., a non-transitory machine-readable storage medium).

The description of certain embodiments included herein is merely exemplary in nature and is in no way intended to limit the scope of the disclosure or its applications or uses. In the included detailed description of embodiments of the present systems and methods, reference is made to the accompanying drawings which form a part hereof, and which are shown by way of illustration specific to embodiments in which the described systems and methods may be practiced. These embodiments are described in sufficient detail to enable those skilled in the art to practice presently disclosed systems and methods, and it is to be understood that other embodiments may be utilized, and that structural and logical changes may be made without departing from the spirit and scope of the disclosure. Moreover, for the purpose of clarity, detailed descriptions of certain features will not be discussed when they would be apparent to those with skill in the art so as not to obscure the description of embodiments of the disclosure. The included detailed description is therefore not to be taken in a limiting sense, and the scope of the disclosure is defined only by the appended claims.

From the foregoing it will be appreciated that, although specific embodiments of the invention have been described herein for purposes of illustration, various modifications may be made without deviating from the spirit and scope of the invention.

The particulars shown herein are by way of example and for purposes of illustrative discussion of the preferred embodiments of the present invention only and are presented in the cause of providing what is believed to be the most useful and readily understood description of the principles and conceptual aspects of various embodiments of the invention. In this regard, no attempt is made to show structural details of the invention in more detail than is necessary for the fundamental understanding of the invention, the description taken with the drawings and/or examples making apparent to those skilled in the art how the several forms of the invention may be embodied in practice.

As used herein and unless otherwise indicated, the terms “a” and “an” are taken to mean “one”, “at least one” or “one or more”. Unless otherwise required by context, singular terms used herein shall include pluralities and plural terms shall include the singular.

Unless the context clearly requires otherwise, throughout the description and the claims, the words ‘comprise’, ‘comprising’, and the like are to be construed in an inclusive sense as opposed to an exclusive or exhaustive sense; that is to say, in the sense of “including, but not limited to”. Words using the singular or plural number also include the plural and singular number, respectively. Additionally, the words “herein,” “above,” and “below” and words of similar import, when used in this application, shall refer to this application as a whole and not to any particular portions of the application.

Of course, it is to be appreciated that any one of the examples, embodiments or processes described herein may be combined with one or more other examples, embodiments and/or processes or be separated and/or performed amongst separate devices or device portions in accordance with the present systems, devices and methods.

Finally, the above discussion is intended to be merely illustrative of the present system and should not be construed as limiting the appended claims to any particular embodiment or group of embodiments. While the present system has been described in particular detail with reference to exemplary embodiments, it should also be appreciated that numerous modifications and alternative embodiments may be devised by those having ordinary skill in the art without departing from the broader and intended spirit and scope of the present system as set forth in the claims that follow. Accordingly, the specification and drawings are to be regarded in an illustrative manner and are not intended to limit the scope of the appended claims.

What is claimed is:

1. A system comprising:
an animatronic skin comprising a plurality of markers configured to provide a light signature, wherein the plurality of markers is embedded at least partially within the animatronic skin;
a camera configured to detect the light signature;
a projector configured to project content onto the animatronic skin; and
a controller configured to:
determine positions of the plurality of markers based on the light signature; and
modify the projected content based on the positions of the plurality of markers.

2. The system of claim 1, further comprising an actuator configured to create a movement of the animatronic skin, wherein the controller is configured to modify the projected content based on the movement of the animatronic skin.

3. The system of claim 1, wherein the plurality of markers is embedded within the animatronic skin to move with the animatronic skin.

4. The system of claim 1, wherein the plurality of markers comprises light-emitting diodes (LEDs) or fiber optics embedded at least partially within the animatronic skin.

5. The system of claim 1, further comprising a light source configured to project an invisible light onto the animatronic skin, wherein the light signature is a light resulting from the invisible light interacting with the markers.

6. The system of claim 5, wherein the invisible light comprises ultraviolet (UV) light or infrared (IR) light.

7. A system comprising:
a light source configured to generate an invisible light;
a camera configured to detect a characteristic of the invisible light; and
a controller configured to:
determine positions of markers associated with a skin of an animatronic based on the characteristic of the invisible light; and
modify a projected content of a projector based on the positions of the markers.

8. The system of claim 7, further comprising the projector, wherein the projector is configured to generate the projected content for projection onto the skin.

9. The system of claim 7, further comprising the skin, wherein the skin comprises the markers, and the markers are embedded at least partially within the skin.

10. The system of claim 7, wherein the markers are defined at least partially by paint comprising ultraviolet (UV) or infrared (IR) pigment.

11. The system of claim 7, wherein the markers are defined by light-emitting diodes (LEDs) or fiber optics, and wherein the LEDs or fiber optics generate or transmit the invisible light.

12. The system of claim 7, further comprising the animatronic and an actuator configured to change a topography of the skin, wherein the controller is configured to modify the projected content based on the change of the topography.

13. The system of claim 7, wherein the light source is configured to emit ultraviolet (UV) light or infrared (IR) light onto the skin, and wherein the camera is configured to detect a light resulting from the UV light or the IR light interacting with the markers.

14. A method for projecting content onto a skin of an animatronic, the method comprising:
generating, by a light source, an invisible light;
detecting, by a camera, a light resulting from the invisible light interacting with markers embedded at least partially within the skin of the animatronic;
determining, based on the light detected by the camera, positions of the markers; and
modifying a projected content of a projector based on the positions of the markers.

15. The method of claim 14, wherein the detecting the light comprises detecting the light reflected off the markers.

16. The method of claim 14, wherein the detecting the light comprises detecting a light generated by the markers.

17. The method of claim 14, further comprising projecting the projected content onto the skin of the animatronic.

18. The method of claim 14, further comprising modifying a topography of the skin of the animatronic, wherein the modifying the projected content comprises adjusting the projected content based on the modified topography.

19. A method of manufacturing a skin of an animatronic, the method comprising:
defining one or more markers within a mold, wherein the one or more markers are configured to provide a light signature; and
pouring a material within the mold, wherein the material defines the skin of the animatronic when cured with the one or more markers embedded therein.

20. The method of claim 19, wherein the defining the one or more markers comprises:
placing a stencil onto the mold; and
spraying a paint through the stencil and onto the mold, wherein the paint comprises ultraviolet (UV) or infrared (IR) pigment configured to provide the light signature.
